(19) United States
(12) Patent Application Publication
(10) Pub. No.: US 2004/0099686 A1
(43) Pub. Date: May 27, 2004

(54) Cutting apparatus of sealed beverage vessel

(76) Inventor: Hee-Kwon Rho, Kyungki-do (KR)

Correspondence Address: GREENBLUM & BERNSTEIN, P.L.C., 1950 ROLAND CLARKE PLACE, RESTON, VA, 20191, US

(21) Appl. No.: 10/381,591

(22) PCT Filed: Nov. 27, 2002
(86) PCT No.: PCT/KR02/02219

(51) Int. Cl. B67D 5/00

(52) U.S. Cl. 222/83

(57) ABSTRACT

Disclosed herein is a valve device for a beverage vessel which includes a hollow body coupled to an opening of the beverage vessel and opened at upper and lower ends thereof; a sealing member attached to the opening of the beverage vessel for sealing the beverage vessel; a vertical moving member fitted in the body and adapted to be vertically movable and rotatable; a cutting device installed at a lower portion of the vertical moving member and adapted to cut the sealing member in accordance with the rotation of the vertical moving member; and a lid rotatably fitted around the body while being coupled to the vertical moving member to rotate it. When the lid rotates, the vertical moving member moves downwardly while rotating to cut the sealing member by the cutting device installed thereto, thereby allowing the sealed vessel opening to be easily opened.

### BACKGROUND OF THE INVENTION

1. Technical Field

The present invention relates to a valve device for a beverage vessel, and more particularly to a valve device for a beverage vessel which is installed at the opening of the beverage vessel and adapted to discharge the contents of the beverage vessel by removing a sealing member attached to the opening of the beverage vessel without separating a body of the valve device from the opening of the beverage vessel.

2. Background Art

In general, the opening of a beverage vessel is sealed with a sealing member in order to prevent the leakage of the contents through the vessel opening or to continually preserve the original state of the contents received in the beverage vessel.

Referring to FIG. 1, a beverage vessel having a conventional valve device is illustrated. In order to open and close the opening of the beverage vessel, the valve device is typically coupled to the opening. As shown in FIG. 1, the valve device includes a body 3 detachably coupled to the opening of the beverage vessel denoted by the reference numeral 1, the opening of the beverage vessel being sealed with a sealing member 2, a vertical moving member 4 fitted in the upper portion of the body 3 while being vertically slidable, and a lid 5 fitted around the body 3 while surrounding the vertical moving member 4. When it is desired to drink the contents of the beverage vessel 1, the user first separates the body 3 from the beverage vessel 1, and then removes the sealing member 2. Thereafter, the user again couples the body 3 to the opening of the beverage vessel 1. In this state, the user separates the lid 5 from the body 3, and then upwardly moves the vertical moving member 4 while grasping the vertical moving member 4 by the fingers, so that the upper surface 4′ of the vertical moving member 4 is vertically spaced from the head portion 3′ of the body 3. As a result, the opening of the beverage vessel 1 is opened. In this state, the user can drink the contents of the beverage vessel 1 by tilting the beverage vessel 1. When the user does not wish to further drink the contents of the beverage vessel 1, the user downwardly presses the vertical moving member 4 using his/her hand, thereby causing the vertical moving member 4 to return to its original position, that is, a closed position. Thus, the opening of the beverage vessel 1 is closed.

However, this valve device is inconvenient in use because it is necessary to perform procedures of separating the body 3 of the valve device from the beverage vessel 1, removing the sealing member 2, and then again coupling the separated body 3 to the beverage vessel 1, in order to discharge the contents of the beverage vessel 1 using the valve device. Furthermore, when it is desired to drink the contents of the beverage vessel 1, the user should upwardly move the vertical moving member 4 using his/her fingers. After drinking, the user has to downwardly move the vertical moving member 4 to its original position using his/her fingers. As a result, there is a sanitation problem in that the portion of the valve device, from which the contents of the beverage vessel is discharged, may be contaminated upon opening or closing the valve device.

### DISCLOSURE OF THE INVENTION

Therefore, the present invention has been made in view of the above mentioned problems involved with the prior art, and it is an object of the present invention to provide a valve device for a beverage vessel which is installed at the opening of the beverage vessel and adapted to discharge the contents of the beverage vessel by removing a sealing member attached to the opening of the beverage vessel without separating a body of the valve device from the opening of the beverage vessel.

It is another object of the present invention to provide a valve device for a beverage vessel which allows the user to open and close the opening of the beverage vessel without the user's fingers coming into contact with the opening of the beverage vessel, thereby maintaining the opening in a clean state.

In accordance with the present invention, these objects are accomplished by providing a valve device for a beverage vessel which includes a hollow body coupled to the opening of the beverage vessel and opened at upper and lower ends thereof; a sealing member attached to the opening of the beverage vessel for sealing the beverage vessel; a vertical moving member fitted in the body to be vertically movable and rotatable; a cutting device installed at a lower portion of the vertical moving member and adapted to cut the sealing member in accordance with the rotation of the vertical moving member; and a lid rotatably fitted around the body while being coupled to the vertical moving member to rotate it.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view illustrating a conventional valve device for a beverage vessel;

FIG. 2 is an exploded perspective view illustrating a valve device for a beverage vessel according to a first embodiment of the present invention;

FIG. 3 is a sectional view illustrating the valve device of the first embodiment shown in FIG. 2 mounted to a beverage vessel;

FIG. 4a is a sectional view illustrating a vertical moving member included in the valve device of the first embodiment;

FIG. 4b is a plan view of FIG. 4a;

FIG. 5 is a bottom view corresponding to a portion “B” of FIG. 4a;

FIG. 6a is a sectional view illustrating a lid included in the valve device of the first embodiment;

FIG. 6b is a cross-sectional view taken along the line A-A of FIG. 6a;

FIG. 7 is a cross-sectional view taken along the line C-C of FIG. 3;

FIG. 8 is a sectional view illustrating a state in which the valve device of the first embodiment is downwardly moved;

FIG. 9 is an exploded perspective view illustrating a valve device for a beverage vessel according to a second embodiment of the present invention;

FIG. 10 is a sectional view illustrating the valve device of the second embodiment mounted to a beverage vessel;

FIG. 11 is a sectional view illustrating a vertical moving member shown in FIG. 9;

FIG. 12 is a bottom view of the vertical moving member shown in FIG. 9;

FIG. 13 is a sectional view illustrating a lid shown in FIG. 9;

FIG. 14 is a cross-sectional view taken along the line C-C of FIG. 10;

FIG. 15 is a plan view of a body shown in FIG. 9;

FIG. 16 is a sectional view illustrating a state in which the valve device of the second embodiment is downwardly moved;

FIG. 17 is a side view of the lid shown in FIG. 9; and

FIG. 18 a sectional view illustrating a valve device for a beverage vessel according to a third embodiment of the present invention mounted to the beverage vessel.

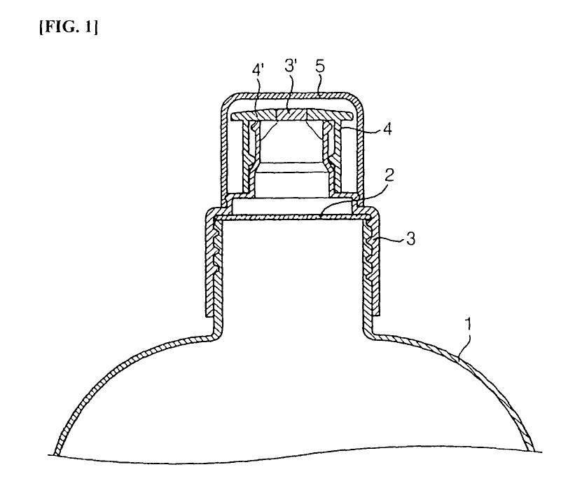

### BEST MODE FOR CARRYING OUT THE INVENTION

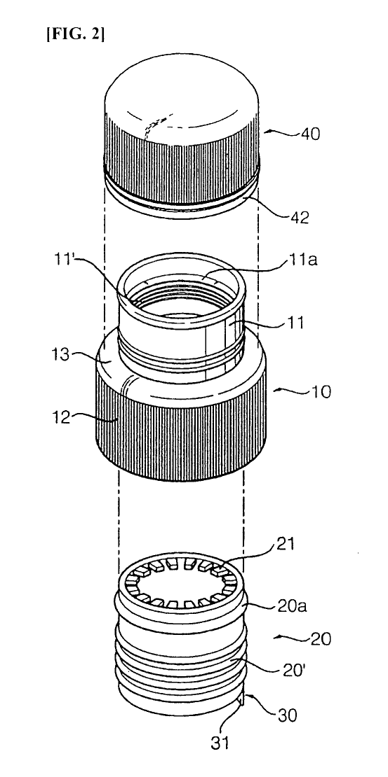

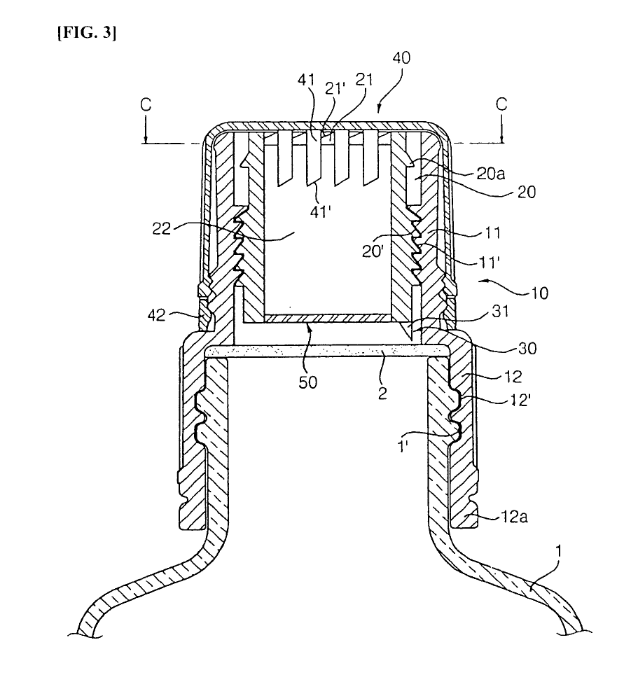

FIG. 2 is an exploded perspective view illustrating a valve device for a beverage vessel according to a first embodiment of the present invention, and FIG. 3 is a sectional view illustrating the valve device of the first embodiment mounted to the beverage vessel.

As shown in FIGS. 2 and 3, the valve device according to the first embodiment of the present invention includes a body 10 coupled to the opening of a beverage vessel 1, the opening of the beverage vessel 1 being sealed with a sealing member 2, a vertical moving member 20 fitted in the body 10 and adapted to move vertically while rotating, thereby allowing the sealing member 2 to be cut by a cutting device 30 installed at a lower portion of the vertical moving member 20, and a lid 40 fitted around the body 10 and adapted to rotate the vertical moving member 20.

The body 10 includes upper and lower hollow cylindrical sections 11 and 12 each opened at both vertical ends thereof. The lower cylindrical section 12 is provided at its inner surface with female threads 12′ to be threadedly coupled with male threads 1′ formed at the opening of the beverage vessel 1.

The upper cylindrical section 11 has a diameter smaller than that of the lower cylindrical section 12. The upper and lower cylindrical sections 11 and 12 are connected to each other at their adjacent ends by an annular flat connecting section 13.

The annular flat connecting section 13 is formed with fine air inlet holes (not shown). The air inlet holes serve to allow the user to easily drink the contents of the beverage vessel 1 by virtue of the inlet air entering into the beverage vessel 1 through them. Preferably, the air inlet holes are circumferentially arranged so that four holes are equally spaced apart from one another by an angle of 90°.

The upper cylindrical section 11 of the body 10 is provided at its inner surface with female threads 11′, and also provided with an inwardly-protruded annular lip 11 a above the female threads 11′.

A skirt member 12a extends downwardly from the lower end of the lower cylindrical section 12 of the body 10 so that it comes into close contact with the outer surface of the beverage vessel around the vessel opening in the assembled state of the valve device. When the body 10 is rotated, it is separated from the skirt member 12a, so that it is separated from the opening of the beverage vessel 1.

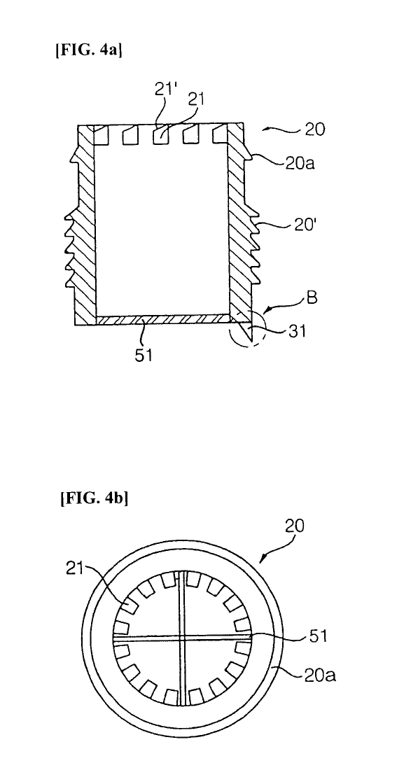

FIG. 4a is a sectional view illustrating the vertical moving member included in the valve device of the first embodiment. FIG. 4b is a plan view of FIG. 4a. FIG. 5 is a bottom view corresponding to a portion “B” of FIG. 4a.

The vertical moving member 20 has a hollow member opened at vertical upper and lower ends thereof and provided at its outer surface with male threads 20′. The vertical moving member 20 is upwardly inserted into the upper cylindrical section 11 of the body 10 at the lower end of the body 10 so that it is threadedly coupled with the female threads 11′ formed at the upper cylindrical section 11 of the body 10.

The vertical moving member 20 is provided at its outer surface with an outwardly-protruded stopper 20a above the male threads 20′. The outwardly-protruded stopper 20a of the vertical moving member 20 is disposed above the inwardly-protruded annular lip 11a of the upper cylindrical section 11 of the body 10. The vertical moving member 20 is adapted to be continuously lowered until the outwardly-protruded stopper 20a thereof comes into contact with the inwardly-protruded annular lip 11a. When the outwardly-protruded stopper 20a comes into contact with the inwardly-protruded annular lip 11a, the downward movement of the vertical moving member 20 is stopped by the inwardly-protruded annular lip 11a. At this time, the vertical moving member 20 is idly rotated.

The male threads 20′ formed at the vertical moving member 20 are downwardly inclined, whereas the female threads 11′ formed at the inner cylindrical section 11 are upwardly inclined. Accordingly, the engagement between the male threads 20′ and the female threads 11′ can be easily achieved by simply inserting the vertical moving member 20 upwardly into the upper cylindrical section 11.

The vertical moving member 20 is provided at its lower end with the cutting device 30. The cutting device 30 is adapted to move downwardly when the vertical moving member 20 rotates, thereby cutting the sealing member 2 attached to the opening of the beverage vessel 1. Preferably, the cutting device 30 includes a single blade 31.

The blade 31 has a cutting edge extending circumferentially, and is positioned so that the outer surface thereof corresponds to an outer diameter of the vertical moving member 20. The blade 31 has a right-angled triangular cross section inclined inwardly.

In a state of the initial installation of the vertical moving member 20 in the body 10, the blade 31 is spaced apart from the sealing member 2 attached to the opening of the beverage vessel 1 at its lower end by a certain distance.

The vertical moving member 20 is provided at its inner surface with a plurality of horizontal holding pieces 21 radially protruded from the upper peripheral edge of the vertical moving member 20 while being uniformly spaced apart from one another. Each horizontal holding piece 21 is formed at its top surface with an inclined surface 21′ having a certain angle of inclination.

In order to upwardly insert the vertical moving member 20 into the body 10 at the lower end of the body 10 while preventing damage to the blade 31, the vertical moving member 20 is provided at the lower portion thereof with an assembly-aid member 50. The assembly-aid member 50 is configured into various shapes.

For instance, the assembly-aid member 50 may include a cross-shaped member 51, which extends through the center of the vertical moving member 20 to intersect the center thereof. The assembly-aid member 50 is coupled to the lower end of the vertical moving member 20 at its respective ends. Although the cross-shaped assembly-aid member 50 is described, the shape of the assembly-aid member may be freely selected from among various shapes.

Due to manufacturing constraints, the horizontal holding pieces 21 are omitted at certain portions lying on the same vertical axis as coupling portions in which the respective ends of the cross-shaped member 51 are coupled to the vertical moving member 20, respectively.

In place of the cross-shaped member 51, the vertical moving member 20 is provided at its inner surface with a plurality of horizontal protrusions (not shown) radially protruded from the lower peripheral edge of the vertical moving member while being uniformly spaced apart from one another. By lightly pressing the horizontal protrusions when the vertical moving member 20 is upwardly inserted into the body 10 at the lower end of the body 10, it is possible to smoothly assemble the vertical moving member 20 in the body 10 while preventing damage to the blade 31.

Due to manufacturing constraints, the horizontal protrusions are alternately arranged with the horizontal holding pieces 21.

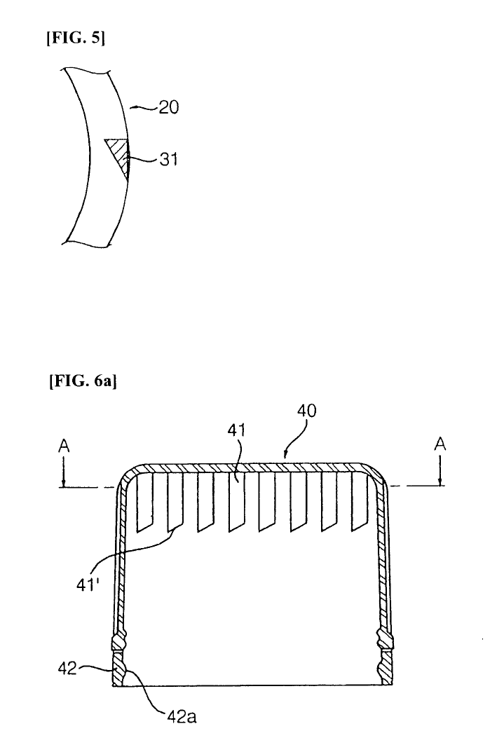

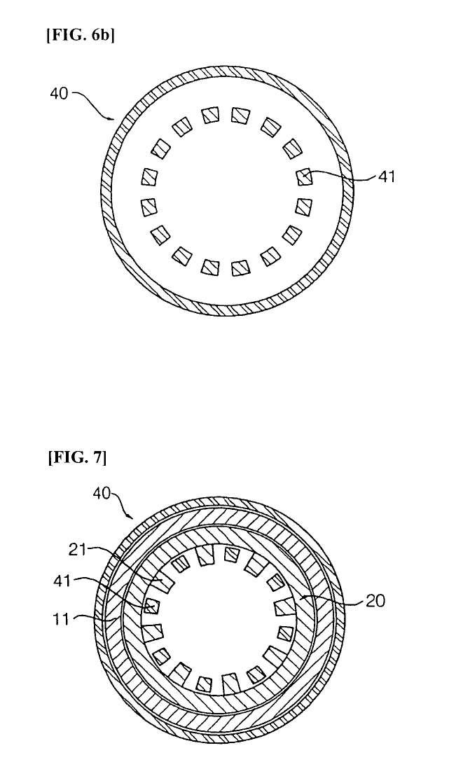

FIG. 6a is a sectional view illustrating a lid included in the valve device of the first embodiment. FIG. 6b is a cross-sectional view taken along the line A-A of FIG. 6a. FIG. 7 is a cross-sectional view taken along the line C-C of FIG. 3.

The lid 40 is fitted around the upper cylindrical section 11 of the body 10. The lid 40 is provided at its inner peripheral portion with a plurality of vertical protrusions 41 extending downwardly from the lower surface of a top wall section while being equally spaced apart from one another. Each vertical protrusion 41 is inserted in one of the gaps defined between the horizontal holding pieces 21, respectively. The lid 40 is also provided at its lower end with a seal strip 42. The seal strip 42 is formed at its inner surface with an annular step 42a is formed at the inner surface of the seal strip 42.

The vertical protrusion 41 is formed at its lower end with an inclined surface 41′. The inclined surface 41′ of the vertical protrusion 41 has the same inclination angle and direction as the inclined surface 21′ of the horizontal holding piece 21. Thereby, the respective vertical protrusions 41 are smoothly inserted in one of the gaps between the horizontal holding pieces 21, respectively.

Now, the opening and closing operation of the valve device for the sealed beverage vessel constructed as stated above will be described.

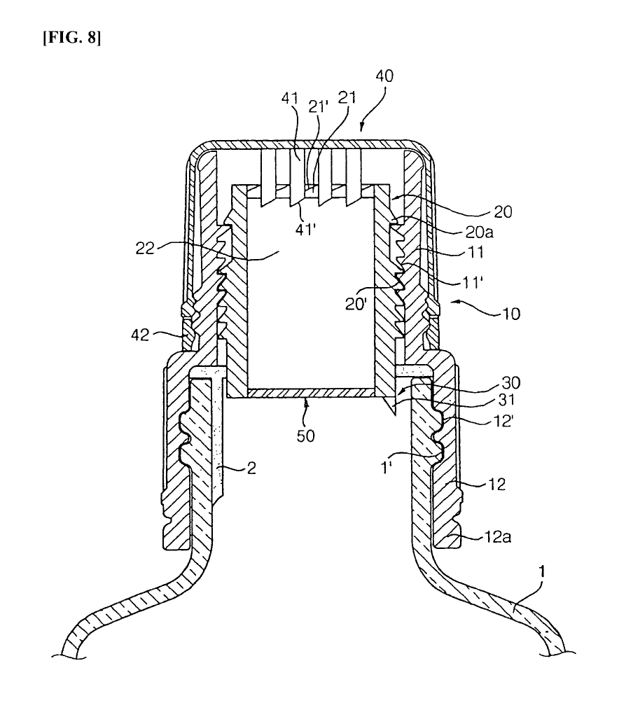

FIG. 8 is a sectional view illustrating a state in which the valve device of the first embodiment is downwardly moved.

As shown in FIG. 8, when the user applies a rotating force to the lid 40 while grasping the lid 40 by his/her hands, the lid 40 is rotated while being separated from the seal strip 42.

As the lid 40 is rotated, the vertical moving member 20 is rotated along with the lid 40 because the respective vertical protrusions 41 of the lid 40 are inserted in one of the gaps between the horizontal holding pieces 21 of the vertical moving member 20, respectively. As the vertical moving member 20 is rotated, the vertical moving member 20 is also moved downwardly because the male threads 20′ formed at the vertical moving member 20 are threadedly coupled with the female threads 11′ formed at the upper cylindrical section 11.

In accordance with the downward movement of the vertical moving member 20, the sealing member 2 attached to the opening of the beverage vessel 1 is adapted to be cut along the circumference thereof by the blade 31 installed to the lower end of the vertical moving member 20. The downward movement of the vertical moving member 20 is continued until the sealing member 2 is cut through about up to 360°. Then, the cut sealing member 2 is pushed downwardly toward the inner wall of the beverage vessel 1 by a lateral pushing force of the vertical moving member 20 applied thereto, thereby causing the vessel opening to be opened.

Where it is desired to drink the contents of the beverage vessel 1, the user separates the lid 40 from the body 10, and then can drink the contents through an outlet opening 32 of the vertical moving member 20 by tilting the beverage vessel 1.

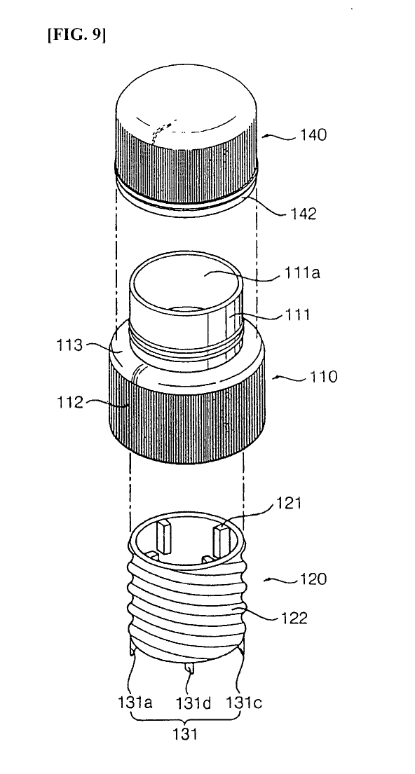

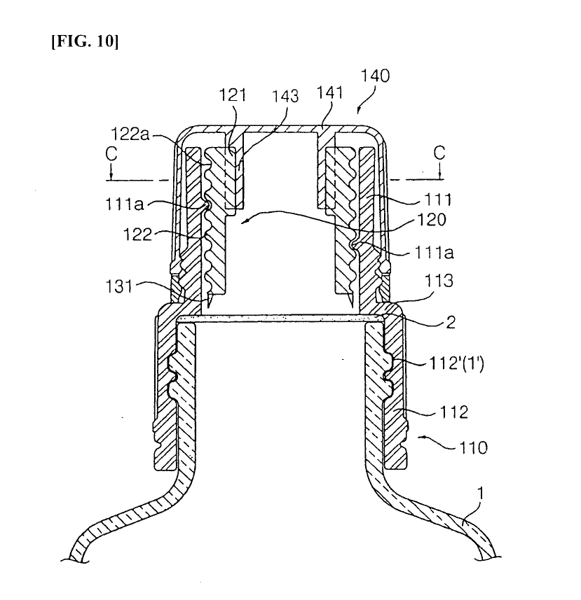

FIG. 9 is an exploded perspective view illustrating a valve device for a beverage vessel according to a second embodiment of the present invention, and FIG. 10 is a sectional view illustrating the valve device of the second embodiment shown in FIG. 9 mounted to the beverage vessel.

The valve device according to the second embodiment of the present invention, as shown in FIGS. 9 and 10, includes a hollow body 110 coupled and fixed to the opening of a beverage vessel 1, the opening of the beverage vessel 1 being sealed with a sealing member 2, a vertical moving member 120 fitted in the body 110 and adapted to move vertically while rotating, thereby allowing the sealing member 2 to be cut by cutting blades 131 installed at the lower end of the vertical moving member 120, and a lid 140 detachably and rotatably fitted around the body 110, and adapted to rotate the vertical moving member 120. The lid 140 is formed with a plurality of outwardly-protruded vertical steps 143a, whereas the vertical moving member 120 is formed at the upper portion of its inner surface with a plurality of inwardly-protruded vertical extensions 121. Since the respective outwardly-protruded vertical steps 143a of the lid 140 are engaged, respectively, with one of the inwardly-protruded vertical extensions 121 of the vertical moving member, the vertical moving member 120 is rotated in accordance with the rotation of the lid 140.

The hollow body 110 includes upper and lower hollow cylindrical sections 111 and 112 each opened at both vertical ends thereof. The lower cylindrical section 112 is provided at its inner surface with female threads 112′ to be threadedly coupled with male threads 1′ formed at the opening of the beverage vessel 1.

The upper cylindrical section 111 has a diameter smaller than that of the lower cylindrical section 112. The upper and lower cylindrical sections 111 and 112 are connected to each other at their adjacent ends by an annular flat connecting section 113.

As shown in FIGS. 10 and 15, the upper cylindrical section 111 is provided at its inner surface with four rising portions 111a arranged in a helical direction.

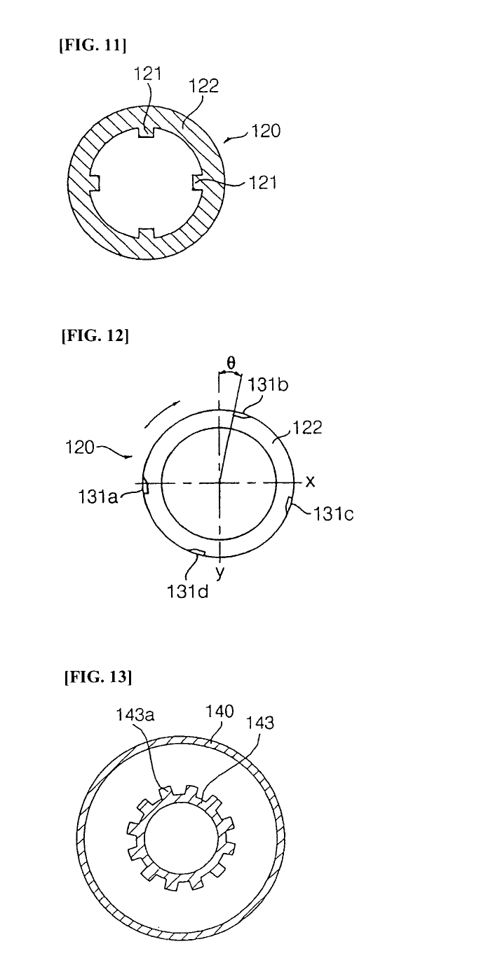

As shown in FIGS. 9 to 12, the vertical moving member 120 includes a hollow cylindrical body 122 opened at both vertical upper and lower ends thereof. The hollow cylindrical body 122 is formed at its outer surface with female threads 122a, and also provided at the bottom surface of the hollow cylindrical body 122 with a plurality of cutting blades 131a to 131d extending downwardly therefrom. As stated above, the hollow cylindrical body 122 is also formed at the upper portion of its inner surface with a plurality of inwardly-protruded vertical extensions 121.

The female threads 122a formed at the hollow cylindrical body 122 are engaged with the rising portions 111a formed at the inner surface of the upper cylindrical section 111 in the helical direction. Thus, the vertical moving member 120 moves downwardly in the helical direction while rotating in accordance with the guidance of the rising portions 111a.

The cutting blades 131a to 131d are adapted to move downwardly when the vertical moving member 120 rotates, thereby cutting the sealing member 2 attached to the opening of the beverage vessel 1. Each of the cutting blades 131a to 131d has a cutting edge extending circumferentially and is positioned so that the outer surface thereof corresponds to an outer diameter of the vertical moving member 120.

The cutting blades 131a to 131d, as shown in FIG. 10, are spaced apart from the sealing member 2 attached to the opening of the beverage vessel 1 at their lower ends in a state of the initial installation of the vertical moving member 120.

As shown in FIG. 12 illustrating the bottom of the vertical moving member 120, the cutting blades 131 includes first to fourth cutting blades 131a, 131b, 131c and 131d. During the rotation of the vertical moving member 120 in a clockwise direction, these cutting blades 131a to 131d move downwardly, and are adapted to cut the sealing member 2. At this time, the first cutting blade 131a is spaced apart from the second cutting blade 131b by an angle of 90°+θ. The second, third and fourth cutting blades 131b, 131c and 131d are equally spaced apart from one another by an angle of 90°. Thus, the fourth cutting blade 131d is spaced apart from the first cutting blade 131a by an angle of 90°−θ.

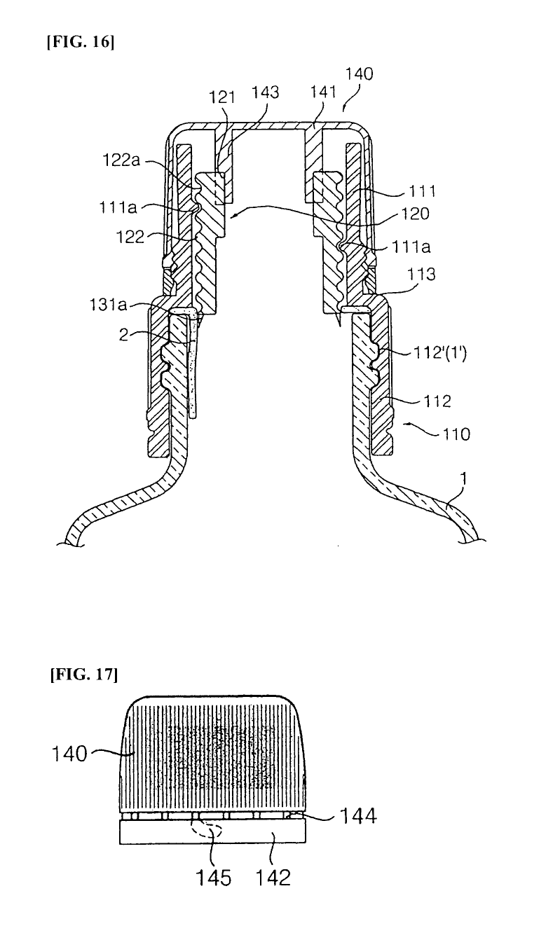

Therefore, when the vertical moving member 120 is rotated at 90° in the clockwise direction after the cutting blades 131a to 131d begin to cut the sealing member 2 while coming into contact with the sealing member 2, the sealing member 2 is cut except its circumferential portion corresponding to an angle θ shown in FIG. 5. Thereby, as shown in FIG. 16, the sealing member 2 is pushed downwardly from the circumferential portion thereof corresponding to the angle θ. In this state, since the first cutting blade 131a has been already positioned under the original position of the sealing member 2 regardless of the further rotating and downward movements of the vertical moving member 120, the circumferential portion of the sealing member 2 corresponding to the angle θ can∝t be cut. As a result, the cut sealing member 2 doesn't fall into the beverage vessel 1.

By appropriately setting the number of the cutting blades, the angle between the cutting blades, and the downward movement distance of the vertical moving member depending on a rotating angle thereof, it is possible to achieve the same effects as stated above.

The lid 140 is fitted around the upper cylindrical section 111 of the body 110. The lid 140 has a top wall section 141, a seal strip 142 formed at the lower end thereof, and an inner cylindrical section 143 extending downwardly from the lower surface of the top wall section 141.

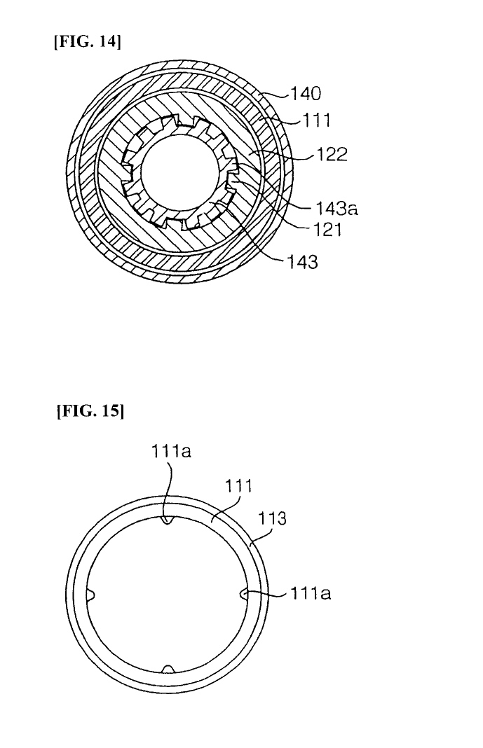

FIG. 13 is a sectional view illustrating a lid shown in FIG. 9, and FIG. 14 is a cross-sectional view taken along the line C-C of FIG. 10.

As shown in FIGS. 13 and 14, the inner cylindrical section 143 is formed at its outer surface with a plurality of outwardly-protruded vertical steps 143a. The inner cylindrical section 143 is fitted in the hollow cylindrical body 122 of the vertical moving member 120. In this state, as the lid 140 is rotated, the outwardly-protruded vertical steps 143a of the lid 140 are engaged respectively with one of the inwardly-protruded vertical extensions 121 of the vertical moving member 120, so that the lid 140 rotates the vertical moving member 120.

As shown in FIG. 17 illustrating the side of the lid 140, the lid 140 is provided at its lower end with the seal strip 142. The lid 140 and the seal strip 142 are connected to each other through connecting pieces 144. The seal strip 142 is formed with a cutting portion 145 connected with one of the connecting pieces 144. When the lid 140 is rotated, the connecting pieces 144 along with the cutting portion 145 are separated from the seal strip 142. At this time, the cutting portion 145 of the seal strip 142 serves as a tamper-proof member, namely, as evidence that the lid 140 is in unopened state.

Although not shown, the vertical moving member is provided at its bottom surface with a lattice-shaped net member. The net member serves to prevent a high pressure from being generated within the beverage vessel 1, thereby preventing the center portion of the sealing member 2 from swelling up.

Now, the method of using the valve device coupled to the beverage vessel 1 will be described.

When the user applies a rotating force to the lid 140 using hands, the lid 140 is rotated while being separated from the seal strip 142.

When the lid 140 is rotated, the vertical moving member 120 is rotated along with the lid 140 because the outwardly-protruded vertical steps 143a of the lid 140 are inserted between the inwardly-protruded vertical extensions 121 of the vertical moving member 120. When the vertical moving member 120 is rotated, the vertical moving member 120 is also downwardly moved in the helical direction under the guidance of the rising portions 111a because the rising portions 111a formed at the upper cylindrical section 111 are engaged with the female threads 122a formed at the vertical moving member 120.

In accordance with the downward movement of the vertical moving member 120, the sealing member 2 attached to the opening of the beverage vessel 1 is cut along the circumference thereof by a plurality of the cutting blades 131a to 131d installed to the lower end of the vertical moving member 120. The downward movement of the vertical moving member 120 is continued until the sealing member is cut through about up to 360°. After completion of cutting, the sealing member 2 is pushed downwardly toward the inner wall of the beverage vessel 1 by a lateral force applied thereto, thereby causing the vessel opening to be opened.

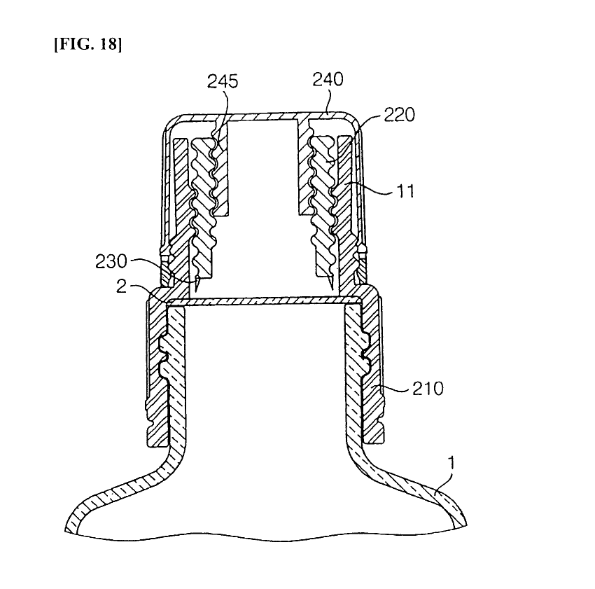

FIG. 18 shows a valve device for a beverage vessel in accordance with a third embodiment of the present invention. The valve device of the third embodiment is different from those of other embodiments in that the vertical moving member moves vertically while rotating under the guidance of the body. The valve device of the third embodiment includes a hollow body 210 having upper and lower cylindrical sections each opened at both vertical ends thereof, the lower cylindrical section being coupled to the opening of the beverage vessel 1, the upper cylindrical section being protruded upwardly beyond the opening of the beverage vessel, a sealing member 2 installed within the body 210 while being attached to the opening of the beverage vessel 1, the sealing member 2 air tightly closing the opening of the beverage vessel 1 in order to prevent the leakage of the contents received in the beverage vessel 1, a lid 240 rotatably and detachably fitted around the upper cylindrical section of the body 210 to seal it, and a hollow vertical moving member 220 opened at its upper and lower ends and inserted within the body 210, the vertical moving member 220 being coupled to the lid 240 so that it moves vertically while rotating in accordance with the rotation of the lid 240, the vertical moving member 220 being provided at its lower end with a device 230 for cutting the sealing member 2.

The vertical moving member 220 is provided at its both inner and outer surfaces with screw grooves. The inner screw grooves formed at the inner surface of the vertical moving member 220 are threadedly coupled with an inner cylindrical section 245 extending downwardly from the lower surface of the lid 240. The outer screw grooves formed at the outer surface of the vertical moving member 220 are threadedly coupled with the body 210. The cutting device 230 comprises a plurality of cutting blades spaced apart from one another along the bottom peripheral edge of the vertical moving member 220.

Now, the opening operation of the valve device in accordance with the third embodiment of the present invention will be described. When the lid 240 is rotated, the vertical moving member 220 is rotated along with the lid 240 and also moved downwardly under the guidance of the body 210. In accordance with the downward movement of the vertical moving member 220, the sealing member 2 attached to the opening of the beverage vessel 1 is cut by the cutting device 230 formed at the lower end of the vertical moving member 220, thereby causing the vessel opening to be opened. In this case, when the body 210 contains any different kind of contents from that of the beverage vessel 1, the valve device allows two or more kinds of contents to be mixed in the beverage vessel 1 and then be discharged therethrough.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

For instance, the valve device according to the present invention is not limited to a beverage vessel, but is usable in all kinds of sealed containers regardless of the contents stored therein. All kinds of containers are included in the scope and sprit of the invention.

### Industrial Applicability

As apparent from the above description, the present invention provides a valve device for a beverage vessel which includes a body coupled to the opening of the beverage vessel, the vessel opening being sealed with a sealing member, a lid rotatably fitted around the body, a vertical moving member fitted in the body and adapted to move downwardly when the lid rotates, thereby opening the opening of the beverage vessel without separating the body from the valve device, and at least one cutting blade mounted at the lower end of the vertical moving member and adapted to cut the sealing member in accordance with the downward movement of the vertical moving member. Accordingly, the user can conveniently discharge the contents of the beverage vessel by cutting the sealing member without separating the body of the valve device from the beverage vessel.

In addition, since the user can open and close the opening of the beverage vessel without the user's fingers coming into contact with the opening of the beverage vessel, it is possible to maintain the opening in a clean state. Accordingly, an improved sanitation effect is obtained.

1. A valve device for a beverage vessel comprising:
a hollow body coupled to an opening of the beverage vessel and opened at upper and lower ends thereof;
a sealing member attached to the opening of the beverage vessel for sealing the beverage vessel;
a vertical moving member fitted in the body and adapted to be vertically movable and rotatable;
a cutting device installed at a lower portion of the vertical moving member and adapted to cut the sealing member in accordance with the rotation of the vertical moving member; and
a lid rotatably fitted around the body while being coupled to the vertical moving member to rotate it.

2. The valve device as set forth in claim 1, wherein the body and the vertical moving member are threadedly coupled to each other.

3. The valve device as set forth in claim 1, wherein the body comprises an upper cylindrical section, a lower cylindrical section having a diameter larger than that of the upper cylindrical section, and an annular flat connecting section extending radially inwardly from an upper end of the lower cylindrical section and adapted to connect the upper and lower cylindrical sections with each other at their adjacent ends.

4. The valve device as set forth in claim 1, further comprising:
separation preventing means provided at the body and the vertical moving member, and adapted to prevent the vertical moving member from separating from the body.

5. The valve device as set forth in claim 4, wherein the separation preventing means comprises an annular lip radially inwardly protruded from an inner surface of the body, and a stopper radially outwardly protruded from an upper end of the vertical moving member, and adapted to be engagable with the annular lip when the vertical moving member is moved downwardly, thereby allowing the vertical moving member to idly rotating.

6. The valve device as set forth in claim 1, wherein the vertical moving member is provided at its upper end with a plurality of horizontal holding pieces radially inwardly protruded from an inner surface thereof while being uniformly spaced apart from one another, and the lid is provided with a plurality of vertical protrusions extending downwardly from a lower surface of a top wall section each adapted to be engaged between adjacent ones of the horizontal holding pieces.

7. The valve device as set forth in claim 6, wherein each of the horizontal holding pieces has an inclined surface at a top surface thereof, each of the vertical protrusions has an inclined surface at a bottom surface thereof, and the respective inclined surfaces of the horizontal holding piece and vertical protrusion have the same inclination angle and direction.

8. The valve device as set forth in claim 1, wherein the cutting device comprises a blade mounted at a lower end of the vertical moving member.

9. The valve device as set forth in claim 8, wherein the blade has a cutting edge extending circumferentially, and is positioned so that an outer surface thereof corresponds to an outer diameter of the vertical moving member, and the blade has a right-angled triangular cross section inclined inwardly.

10. The valve device as set forth in claim 1, the vertical moving member is provided at its lower portion with an assembly-aid member in order to upwardly insert the vertical moving member into the body while preventing damage to the cutting device.

11. The valve device as set forth in claim 10, wherein the assembly-aid member is a cross-shaped member extending through the center of the vertical moving member to intersect the center thereof, and is coupled to the lower end of the vertical moving member at its respective ends.

12. The valve device as set forth in claim 1, wherein the body is provided at its inner surface with a plurality of rising portions arranged in a helical direction, and the vertical moving member is formed at its outer surface with female threads to be threadedly coupled with the rising portions.

13. The valve device as set forth in claim 1, wherein the vertical moving member is provided at the inner surface thereof with a plurality of vertical extensions radially inwardly protruded from an upper portion of the vertical moving member while being uniformly spaced apart from one another, and the lid is provided with a plurality of vertical steps extending downwardly from the lower surface of the top wall section thereof each adapted to be engaged between adjacent ones of the vertical extensions.

14. The valve device as set forth in claim 13, wherein the vertical steps are formed at an outer peripheral surface of an inner cylindrical section extending downwardly from the lower surface of the top wall section of the lid.

15. The valve device as set forth in claim 1, wherein the cutting device comprises a plurality of cutting blades spaced apart from one another, each blade having a cutting edge extending circumferentially.

16. The valve device as set forth in claim 15, wherein a first one of the cutting blades and a second one of the cutting blades define a first angle therebetween, the first angle being larger than a second angle defined between adjacent ones of remaining cutting blades and a third angle defined between each of the first and second blades and an adjacent one of the remaining cutting blades.

17. The valve device as set forth in claim 16, wherein the cutting blades comprises four blades, wherein the first angle is more than 90°, and the second and third angles are not more than 90°.

18. The valve device as set forth in claim 1, wherein the lid is provided at a lower portion thereof with a seal strip.

19. The valve device as set forth in claim 18, wherein the lid and seal strip are connected to each other through connecting pieces, and the seal strip has a cutting portion adapted to be separated along with the connecting pieces when the connecting pieces are separated from the seal strip.

20. The valve device as set forth in claim 1, wherein the lid has the inner cylindrical section extending downwardly from the lower surface of the top wall section thereof and adapted to be coupled with the vertical moving member.

21. The valve device as set forth in claim 20, wherein the vertical moving member comprises inner and outer screw grooves at both inner and outer surfaces thereof, the inner screw grooves being threadedly coupled with the inner cylindrical section, the outer screw grooves being threadedly coupled with the body.
